(19) United States
(12) Patent Application Publication
(10) Pub. No.: US 2025/0296691 A1
(43) Pub. Date: Sep. 25, 2025

(54) POWER MANAGEMENT SYSTEM FOR UAV HYBRID POWERPLANT

(71) Applicant: Elroy Air, Inc., South San Francisco, CA (US)

(72) Inventors: Jon Reeves, South San Francisco, CA (US); Pablo Menendez-Aponte, South San Francisco, CA (US)

(73) Assignee: Elroy Air, Inc., South San Francisco, CA (US)

(21) Appl. No.: 19/082,713

(22) Filed: Mar. 18, 2025

Related U.S. Application Data
(60) Provisional application No. 63/567,161, filed on Mar. 19, 2024.

(51) Int. Cl. B64D 31/18; B64D 27/33; B64U 50/30; H02J 7/00

(52) U.S. Cl. CPC B64D 31/18; B64D 27/33; B64U 50/30; H02J 7/0047; B64D 2221/00

(57) ABSTRACT

An Unmanned Aerial Vehicle power management system is configured to match and manage power demands with combined power output from the power storage devices and dynamic generation via a turbine (combustion) motor, while preventing overcurrent and under voltage loads on the power storage devices. The powerplant and power management system of the present invention are, in one embodiment, directed for use with a vertical take-off and landing (VTOL) UAV having multiple forward propulsion propellers (FP) and multiple vertical lift (VL) propellers.

### RELATED APPLICATION

The present application relates to and claims the benefit of priority to U.S. Provisional Patent Application No. 63/567,161 filed Mar. 19, 2024 which is hereby incorporated by reference in its entirety for all purposes as if fully set forth herein.

### BACKGROUND OF THE INVENTION

### Field of the Invention

The present invention relates to the field of aerial vehicles, in particular to hybrid-electric powertrains for aerial vehicles.

### Relevant Background

UAVs, or drones, are well-suited to applications where a traditional manned aircraft could be used but the physical presence of a human operator or pilot is undesirable or impractical. For example, in circumstances where a human operator would face risks that cannot be mitigated, such as flight in poor weather conditions, or in the presence of ground hazards such as radiation or toxic emissions, or in cases where the pilot faces extreme exhaustion or boredom, such as during a long flight in repetitive conditions, use of a UAV may be preferred to a manned aircraft.

For these reasons, UAVs are often used for different missions previously performed by manned aircraft, to include cargo transport; supplemental power storage, intelligence, surveillance, and reconnaissance (“ISR”); command and control operations; and global strike missions. Specifically, there is a demand for UAV systems with increased carrying capacity. For example, the US military recently sought development of a UAV that could carry a LiDAR system having a diameter of 18-21 inches and weighing 200-300 pounds.

Many larger models of UAVs are expensive, costing hundreds of millions of dollars, and are typically adapted for specific missions. For example, most large UAVs used for ISR carry the necessary equipment in their fuselage, which makes it difficult to adapt them for other functions. Some of these disadvantages can be mitigated using a removably attachable mission pod, which is a volume for carrying a payload that is mounted externally to an aerial vehicle's fuselage. Use of such pods allows the aerial vehicle to have a smaller fuselage, which increases the structural efficiency of the aerial vehicle by reducing its enclosed volume. Further, the use of a pod with an aerial vehicle improves the system's modularity and flexibility, i.e., a single fuselage is rendered compatible with many types of mission, as well as the use of diverse equipment types for similar missions.

Supplying power to a such a UAV that can carry heavy payloads, and flexible enough to perform different mission types is challenging, especially when incorporating Vertical Takeoff and Landing (VTOL) capabilities. Many smaller UAVs are powered by purely electric powerplants, because electric power is responsive to control requirements, and allows rapid adjustment to variable flight conditions facing smaller and lighter aircraft. Battery technologies, however, suffer from low energy density, and battery weight increases prohibitively as power demands increase. Therefore, for larger, heavier UAVs, electric power alone is inadequate.

Petroleum powerplants have long been used for traditional aircraft because the high energy density of aviation fuel allows for efficient powering of very large aircraft. Some larger UAVs accordingly use internal combustion piston engines as powerplants. Piston engines, however, are heavy and inefficient relative to turbine engines, and cause undesirable flight characteristics for UAVs due to frequent torque changes and vibrations caused by their operation. Turbine engines are more efficient, and present fewer vibrational issues and a smoother torque profile than piston engines. However, turbine engines require time to spool up and spool down during periods of changing power demands. A turbine engine alone, therefore, would be an impractical powerplant for a larger UAV because it would be insufficiently responsive to the dynamic power requirements of the aircraft.

It is apparent that a need exists for a hybrid UAV powerplant that combines the responsiveness of an electric motor with the power and efficiency of a turbine engine. Combining these two types of powerplants into a hybrid powerplant presents a significant technical challenge. Use of the turbine engine can supply steady power to allow flight of a larger UAV but cannot respond rapidly enough during transitional portions of the flight, such as takeoff, climb, descent, and landing. The electric motor can provide the needed responsiveness during these periods, but due to lag between the turbine's power output and demand, there is a substantial risk of overvoltage on the batteries during these transitional periods. Therefore, it is apparent that use of a hybrid electric, gas turbine powerplant requires the use of a power management system to ensure the UAV is supplied adequate power during all flight envelopes, while avoiding catastrophic overvoltage on its batteries and electric thrusters.

The engine-generator system provides sustained power output, while the battery-motor system offers rapid power response. However, batteries have limited energy capacity and can only absorb a maximum charge current before risking damage or failure. Surplus power from the generator charges the batteries, but uncontrolled charging can lead to overcurrent conditions.

A key challenge lies in balancing the power generation from the engine-generator with the power absorption by the batteries, while respecting component limits and ensuring vehicle controllability. As batteries deplete during operation, the diminishing available power must be judiciously distributed between propulsion systems, such as forward thrust and vertical lift, to maintain critical functions.

As power demand increases during vehicle operation, the generator output is increased through a torque control algorithm until it reaches saturation. Once all power systems are saturated, if the power demand continues to rise due to control inputs, the batteries may experience overcurrent or undervoltage conditions, triggering a catastrophic chain of powertrain faults that can compromise vehicle controllability and safety.

To address the issue of balancing power generation and absorption within safe limits for component tolerances and vehicle controllability, as well as managing power distribution between forward thrust and vertical lift propulsion systems as energy depletes, some patents have been developed. For example:
US20150142229A1 discloses apparatuses, methods and systems for hybrid powertrain control that determine a total output demanded of a powertrain based on an operator input, a battery output target based on a battery state of charge, and an engine output target based on the total output demanded and the battery output target. However, it lacks dynamic adjustment based on real-time vehicle and operating conditions, as well as intelligent battery management to extend battery life across different drive cycles.
U.S. Pat. No. 9,592,817B2 provides a system and method for controlling energy distribution within a HEV powertrain by generating a feedforward battery power value in response to a driver torque request, a feedback battery power modification value in response to actual battery power and the driver torque request and calculating a battery power request based on the sum of these values. However, it does not address the integration of advanced energy management algorithms to optimize energy distribution based on factors like battery state of charge, vehicle weight, and driving conditions, as well as seamless integration with vehicle control systems for better coordination and improved driving experience.
U.S. Pat. No. 9,067,589B1 describes a vehicle with a powertrain having an engine and an electric machine, where a controller generates forecasted torque allocation between the engine and the electric machine for predetermined route segments based on predicted driver demand. However, the patent lacks enhanced predictive algorithms that incorporate accurate data on driver demand, traffic conditions, and vehicle dynamics, as well as advanced battery management techniques to optimize battery life and performance.

Existing hybrid electric vehicle powertrains suffer from the following drawbacks:
Lack of dynamic coordination between the engine-generator and battery-motor subsystems to optimize power flow while respecting component constraints and prioritizing critical vehicle functions. The power management strategies are not adaptive to real-time vehicle operating conditions and energy levels.
Existing power management strategies do not adequately address balancing power generation from the engine-generator and power absorption by the batteries within their respective limits, leading to potential component damage or system failure.
Inability to effectively prevent overcurrent or undervoltage conditions that can trigger a catastrophic chain of powertrain faults when power demand exceeds the available power from both sources. The system lacks intelligent power limiting mechanisms to maintain vehicle safety and control.
Existing systems do not seamlessly integrate power management with vehicle control systems, resulting in suboptimal performance and potential conflicts between power distribution and control objectives.
Inefficient distribution of diminishing available power between propulsion systems, such as forward thrust and vertical lift, as batteries deplete energy during operation. The power management strategies do not adequately prioritize critical functions to ensure continued vehicle control.
Absence of advanced energy management algorithms that can extend battery life across different drive cycles by optimizing energy distribution based on factors like battery state of charge, vehicle weight, and driving conditions.

Therefore, there is a need for advanced power management strategies that can dynamically coordinate the engine-generator and battery-motor subsystems in UAVs. These strategies should optimize power flow, respect component constraints, prioritize critical vehicle functions, and prevent hazardous operating conditions that could compromise vehicle safety and controllability.

Additional advantages and novel features of this invention shall be set forth in part in the description that follows, and in part will become apparent to those skilled in the art upon examination of the following specification or may be learned by the practice of the invention. The advantages of the invention may be realized and attained by means of the instrumentalities, combinations, compositions, and methods particularly pointed out in the appended claims.

### SUMMARY OF THE INVENTION

A set of power management strategies for balancing the power sources and power sinks in a hybrid-electric powertrain for an aerial vehicle is hereafter described by way of example. The present invention dynamically adjusts control schemes based on real-time conditions, uses advanced predictive algorithms incorporating accurate data, seamlessly integrates hybrid powertrains with vehicle control systems, and coordinates power generation, absorption, and critical function maintenance in response to varying power demands and aerial conditions.

The present invention provides a set of power management strategies for balancing the power sources and power sinks in a hybrid-electric powertrain for an aerial vehicle and has the following beneficial effects.
It ensures that power generation and absorption are kept within safe limits for all constraints, including component tolerances and vehicle controllability requirements, by coordinating the contributions of the power sources (combustion engine-based generator and electric batteries) and power sinks (forward thrust and vertical lift propulsion systems).
It maintains critical functions such as altitude and stability while allowing degradation in deprioritized axes like yaw and translation at high power demand, thereby meeting power requirements and preventing catastrophic powertrain failure due to overcurrent/undervoltage conditions caused by excessive power demand.
It addresses the inability of combustion engines to change power output quickly due to physical inertial properties, while meeting the agility and controllability requirements of aerial vehicles, by incorporating a thruster “rate limiter” block that limits thruster command rates below a total torque threshold to allow the high-inertia generator time to “keep up” with changing demand before saturating.
It mitigates the risk of exceeding the limited power absorption capacity of batteries, which can lead to faults and total powertrain shutdown, by modulating the primary power user (thrusters) to control power absorption and implementing a thruster “rate limiter” block that limits thruster command rates below a total torque threshold.
It responds dynamically to changes in power demand and available power throughout the flight duration, as the batteries deplete, by incorporating a generator “torque control algorithm” that increases generator output in response to increasing demand until saturation, and by prioritizing thruster commands based on their effects on roll, pitch, yaw, heave, or translation, deprioritizing yaw and longitudinal axes at high power demand.
It enables dynamic coordination between the engine-generator and battery-motor subsystems to optimize power flow while respecting component constraints and prioritizing critical vehicle functions, adapting to real-time vehicle operating conditions and energy levels.
It facilitates efficient distribution of diminishing available power between propulsion systems, such as forward thrust and vertical lift, as batteries deplete energy during operation, by prioritizing critical functions to ensure continued vehicle control.
It incorporates advanced energy management algorithms that can extend battery life across different drive cycles by optimizing energy distribution based on factors like battery state of charge, vehicle weight, and flight conditions.
It seamlessly integrates power management with control systems, enabling optimal performance and harmonious coordination between power distribution and control objectives.

The present invention further provides a method for managing power in a hybrid-electric powertrain, which includes:
implementing a generator torque control algorithm to dynamically adjust generator output in response to increasing power demand until reaching saturation;
implementing a thruster rate limiter block between the autopilot and motor controllers to adjust motor current commands based on thrust requests from the autopilot, instantaneous measured battery currents, and the enable/disable status of the generator's torque control algorithm. This block limits the rate of change in thruster commands below a predetermined total torque threshold, expressed as the sum of individual thruster torque values in Newton meters. When operating below this threshold, the rate limiter actively constrains the rate of change in thruster commands to allow the high-inertia generator sufficient time to respond to changing power demands before saturating. Rapid changes in power demand are primarily absorbed by the batteries during this phase. Above the threshold, the rate limiter bypasses, allowing thruster commands to pass through without adjustment;
monitoring the power demand; and when necessary
implementing a power mismatch handling block at the autopilot output to adjust motor commands based on measured high voltage bus voltage, bus current, per-string instantaneous current, and vehicle level applied acceleration commands from the autopilot, to prioritize critical functions and limit power usage.

The features and advantages described in this disclosure and in the following detailed description are not all-inclusive. Many additional features and advantages will be apparent to one of ordinary skill in the relevant art in view of the drawings, specification, and claims hereof. Moreover, it should be noted that the language used in the specification has been principally selected for readability and instructional purposes and may not have been selected to delineate or circumscribe the inventive subject matter; reference to the claims is necessary to determine such inventive subject matter.

### BRIEF DESCRIPTION OF THE DRAWINGS

The aforementioned and other features and objects of the present invention and the manner of attaining them will become more apparent, and the invention itself will be best understood, by reference to the following description of one or more embodiments taken in conjunction with the accompanying drawings, wherein:

FIG. 1 depicts a front left quadrant view of a vertical take-off and landing (“VTOL”) UAV for use with a mission pod.

FIG. 2A depicts a right-side view of a UAV for use with a mission pod.

FIG. 2B depicts an underside view of a UAV as used in embodiments of the disclosed invention.

FIG. 3 depicts a power optimization curve as would be known to one of reasonable skill in the relevant art.

FIG. 4A depicts a block diagram of a hybrid powertrain and power management system as used in embodiments of the disclosed invention.

FIG. 4B depicts a block diagram of communication and power flow for a hybrid powertrain and power management system as used in embodiments of the disclosed invention.

FIG. 5 is a flowchart of a methodology for hybrid powertrain and power management according to one embodiment of the present invention.

The Figures depict embodiments of the present invention for purposes of illustration only. Like numbers refer to like elements throughout. In the figures, the sizes of certain lines, layers, components, elements or features may be exaggerated for clarity. One skilled in the art will readily recognize from the following discussion that alternative embodiments of the structures and methods illustrated herein may be employed without departing from the principles of the invention described herein.

### DESCRIPTION OF THE INVENTION

Disclosed are devices, systems, and methods of power management for a hybrid electric and turbine powered Unmanned Aerial Vehicle (UAV). Specifically, the power management system is configured to match the power demands with that of the combined power output from the electric storage devices (batteries) and a turbine (combustion) motor, while preventing overcurrent and under voltage loads on the battery system. The powerplant and power management system of the present invention are, in one embodiment, directed for use with a vertical take-off and landing (VTOL) UAV having multiple forward propulsion propellers (FP) and multiple vertical lift (VL) propellers.

In one embodiment of the present invention, a VTOL UAL utilizes a hybrid-power system by which thrusters, both for vertical and horizontal flight, are powered by one or more on batteries. To optimize weight of the batteries in consideration of useful load of the UAL, battery size and capacities are reduced that would ordinarily be insufficient to support continuous aerial operations. As power is drained from the batteries, an onboard combustion based generator resupplies power, thereby recharging/supplementing the batteries.

Power remains of electric motors is instantaneous and thus the rate at which power is sought from the batteries can result in an excessive outlay of current. Combustion power plants, especially turbine based power plants, have inherent responsive lags both respect to creasing production of power due to increased demand, and decreasing power supplementation once demand has been appeased.

To prevent damage to electrical components such as the batteries as well as mechanical features associated with the thrusters, power demand and resupply must be carefully and optimally managed.

Embodiments of the present invention are hereafter described in detail with reference to the accompanying Figures. Although the invention has been described and illustrated with a certain degree of particularity, it is understood that the present disclosure has been made only by way of example and that numerous changes in the combination and arrangement of parts can be resorted to by those skilled in the art without departing from the spirit and scope of the invention.

The following description with reference to the accompanying drawings is provided to assist in a comprehensive understanding of exemplary embodiments of the present invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

The terminology used herein is for the purpose of describing particular embodiments only and is not intended to be limiting of the invention. As used herein, the singular forms “a,” “an” and “the” are intended to include the plural forms as well, unless the context clearly indicates otherwise. Thus, for example, reference to “a component surface” includes reference to one or more of such surfaces.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

It will be also understood that when an element is referred to as being “on,” “attached” to, “connected” to, “coupled” with, “contacting”, “mounted” etc., another element, it can be directly on, attached to, connected to, coupled with or contacting the other element or intervening elements may also be present. In contrast, when an element is referred to as being, for example, “directly on,” “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under,” “below,” “lower,” “over,” “upper” and the like, may be used herein for ease of description to describe one element or feature's relationship to another element(s) or feature(s) as illustrated in the figures. It will be understood that the spatially relative terms are intended to encompass different orientations of a device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of “over” and “under”. The device may be otherwise oriented (rotated 90 degrees or at other orientations) and the spatially relative descriptors used herein interpreted accordingly. Similarly, the terms “upwardly,” “downwardly,” “vertical,” “horizontal” and the like are used herein for the purpose of explanation only unless specifically indicated otherwise.

Included in the description are flowcharts depicting examples of the methodology which may be used for hybrid electric and turbine power management is an UAV. In the following description, it will be understood that each block of the flowchart illustrations, and combinations of blocks in the flowchart illustrations, can be implemented by computer program instructions. These computer program instructions may be loaded onto a computer or other programmable apparatus to produce a machine such that the instructions that execute on the computer or other programmable apparatus create means for implementing the functions specified in the flowchart block or blocks. These computer program instructions may also be stored in a computer-readable memory that can direct a computer or other programmable apparatus to function in a particular manner such that the instructions stored in the computer-readable memory produce an article of manufacture including instruction means that implement the function specified in the flowchart block or blocks. The computer program instructions may also be loaded onto a computer or other programmable apparatus to cause a series of operational steps to be performed in the computer or on the other programmable apparatus to produce a computer implemented process such that the instructions that execute on the computer or other programmable apparatus provide steps for implementing the functions specified in the flowchart block or blocks.

Accordingly, blocks of the flowchart illustrations support combinations of means for performing the specified functions and combinations of steps for performing the specified functions. It will also be understood that each block of the flowchart illustrations, and combinations of blocks in the flowchart illustrations, can be implemented by special purpose hardware-based computer systems that perform the specified functions or steps, or combinations of special purpose hardware and computer instructions.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve the manipulation of information elements. Typically, but not necessarily, such elements may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” “words”, or the like. These specific words, however, are merely convenient labels and are to be associated with appropriate information elements.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

Upon reading this disclosure, those of skill in the art will appreciate still additional alternative structural and functional designs for a system and a process hybrid power management through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

### Multi-Copter UAV

Collectively, patent applications U.S. 16/172,470 (“Compound Multi-Copter Aircraft”), U.S. 16/227,400 (“Unmanned Vehicle Cargo Handling and Carrying System”), and U.S. 17/070,037 (“Mission Pod for Unattended UAV Operations”) disclose UAVs and mission pods for transporting a diverse range of cargo payloads and are incorporated by reference in their entirety, herein. The UAVs sustain flight through use of multiple, e.g., four, horizontally oriented propeller motors to provide forward propulsion and yaw control, and multiple, e.g., eight, vertically oriented propeller motors to provide vertical lift, roll control, and pitch control.

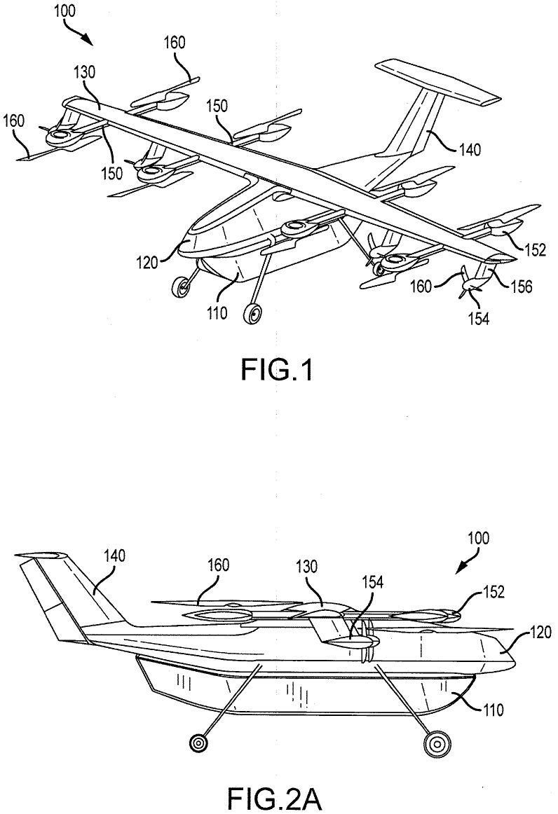

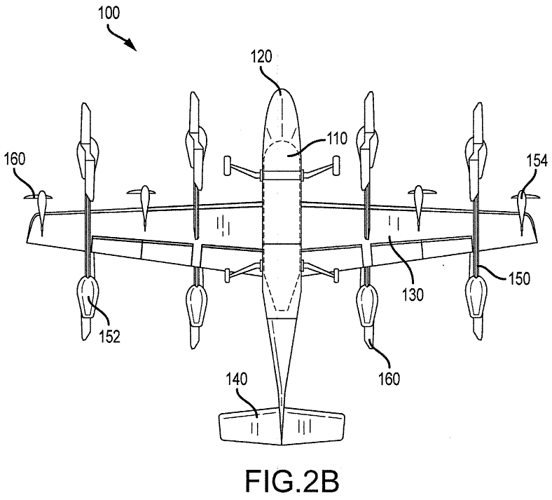

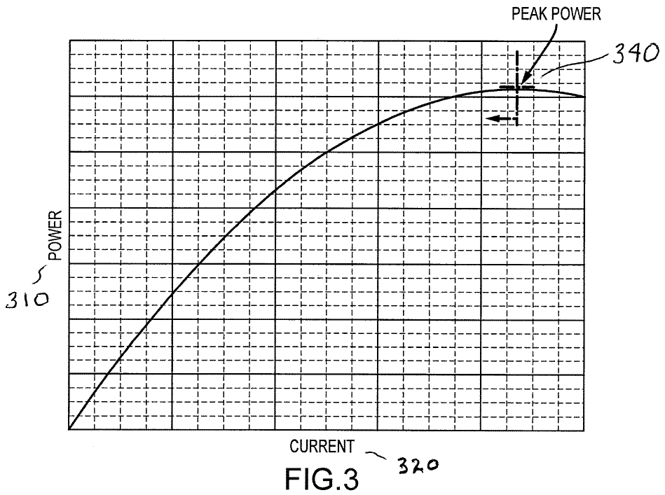

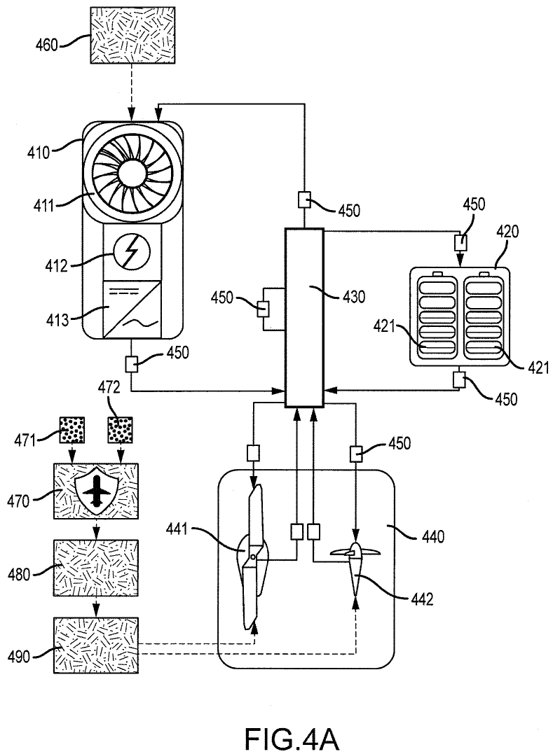

With reference to FIGS. 1, 2A, and 2B, a VTOL UAV with multiple propellers and a hybrid electric turbine powerplant is depicted. FIG. 1 depicts a top perspective view of the UAV, while A depicts the aircraft from the side, and FIG. 3 depicts the aircraft from below. The UAV 100 includes a fuselage 120, wings 130, a T-tail 140, propellers 160, and detachable mission pod 110. There are four booms 150 attached to the wings 130, two on either side of the fuselage 120, with two VL motor pods 152 attached to each end of the four booms 150. The VL motor pods 152 each drive a propeller 160 and enable the vertical lift functionality of the UAV. Also depicted are four FP motor pods 154, each attached to a mount 156 and arranged with two FP motor pods on each wing 130. The FP motor pods each drive a propeller 160 and contribute to the forward thrust of the aircraft.

The fuselage of the UAV contains computing equipment, electrical power storage in the form of batteries, an internal combustion turbine engine, fuel storage, a generator powered by the turbine to supply electrical power to the batteries and motor pods, and the hybrid power management system. The UAV is further configured for use with a detachable mission pod 110 or container that can accommodate diverse missions, or that can be readily re-purposed for ISR, cargo, command and control, or global strike missions.

Unlike a conventional aircraft, the UAV is controlled through power allocation to the various thrusters in vertical flight modes and is controlled by traditional flight control surfaces and/or power allocation to the various thrusters in cruise mode. Control allocation is accomplished through the UAV's autopilot, and is divided into two systems, the Vertical Lift System and the Forward Propulsion System. The FP System controls the four horizontally mounted FP thrusters, and primarily provides longitudinal acceleration, and yaw control. The VL System controls the eight vertically mounted VL thrusters, and primarily provides vertical lift, roll control, and pitch control.

Control allocation is accomplished through symmetric commands where possible to maximize efficiency. For example, roll commands are performed using net zero power by decreasing power to VL thrusters on one wing while increasing power to VL thrusters on the other wing in equal amounts. Such power allocation causes the low-power wing to dip and the UAV to turn into that wing. Pitch changes can be made through symmetric commands in a similar way. For example, to increase the UAV's pitch, VL thrusters forward of the wing are ordered to increase power, while VL thrusters to the rear of the wing decrease power. Yaw can be also managed through symmetric commands to the FP thrusters.

### Power Management System

A hybrid-electric powertrain system for an aerial vehicle, according to one embodiment of the present invention, comprises a combustion engine-based generator, electric batteries, a forward thrust propulsion system, and a vertical lift propulsion system. The system further includes a generator torque control algorithm configured to increase the output of the combustion engine-based generator in response to increasing power demand until reaching a saturation point. The algorithm aims to maximize the generator's sustained power contribution while preventing battery overload.

The system also includes a thruster modulation system configured to control power absorption by adjusting the operation of the forward thrust propulsion system and the vertical lift propulsion system, which are the primary power users. This system regulates the power drawn from the powertrain to prevent exceeding the power absorption capacity of the electric batteries.

A thruster rate limiter block is positioned between the autopilot and motor controllers. This block limits the rate of change in thruster commands below a predetermined total torque threshold, expressed as the sum of individual thruster torque value. When in the low power band and operating below this threshold, the rate limiter actively constrains the rate of change in thruster commands to allow the high-inertia generator sufficient time to respond to changing power demands before saturating. Rapid changes in power demand are primarily absorbed by the batteries but rapid changes in discharge and or charging rates can be detrimental. Above the threshold, the rate limiter bypasses, allowing thruster commands to pass through without adjustment.

For example, during the landing phase of flight for a VTOL UAV power demands are high. Indeed, the power demand from the power sinks, the thrusters, is larger in most instances that can be continuously supplied by the batteries. This means that during the landing phase (and takeoff as well) the batteries are being drained faster than the generator, operating a full capacity, can replenish them but relative charging and discharging rate are constant. Upon landing, the power demand drops substantially and quickly. However, the generator, as it is driven by a combustion based power source, possesses an inertial delay unlike the instantaneous responsiveness of an electric motor. This can cause large spikes in the rate of power discharge and charging. The rate limiter of the present invention limits the rate of change of power demand thereby preventing spikes in power discharge or charging.

Lastly, a thruster command prioritization system prioritizes thruster commands based on their effects on roll, pitch, yaw, heave, or translation. Commands affecting vertical, roll, and pitch axes, which are critical for maintaining altitude and stability, are given the highest priority. Yaw and longitudinal axes commands are deprioritized. As power demand exceeds the available power, this system allows for a controlled degradation in the deprioritized yaw and translation axes to limit power usage while maintaining critical functions.

In the mid-power band, where power demand is within the system's capabilities, thruster commands from control laws are allowed to pass through directly to the thrusters without adjustment.

For the high power scenario, the system relies on the power mismatch controller to manage power demands. At high power flight regimes, the turbogenerator is operating at its saturation point, so the torque controller is not applying corrections. The total torque value of the thrusters may be above or below the activation threshold, so the rate limiter may be active. If the rate limiter is active, thrust commands will be adjusted by the power mismatch controller and then receive further adjustment from the rate limiter. Upon receiving thrust commands from the autopilot or similar input via the rate limiter, the power mismatch controller first calculates the total power required to achieve the thrust commands. Then the controller compares the total power required to the power available. If the power plant has sufficient power available, the controller makes no further modifications to the thrust commands. If the available power is insufficient, the power mismatch controller reallocates power from the yaw, lateral, and longitudinal degrees of freedom to the roll, pitch, and vertical degrees of freedom. Once it has reallocated power, the power mismatch controller applies modifications to the thrust commands for each thruster.

The present invention implements a proportional, integral, or derivative controller, or a combination thereof, to determine the battery power command based on the error between the dynamically determined state of charge target and the actual state of charge information. Dead zone limits or hysteresis logic may be incorporated to improve efficiency by preventing the control loop from continuously modulating the electronics for near-zero power commands.

The disclosed power management system balances the two major power sources in a hybrid UAV powertrain, specifically the combustion engine-based generator and the electric batteries. For VTOL UAVs, battery power provides substantial overall power output with quick response times, accommodating large changes in power demand on short time scales. Such responsiveness to changes in power demand is required for aerodynamic controllability, especially for propeller-driven VTOL aircraft. However, as battery size and capacity is reduced to optimize aircraft useful load, battery power alone is inadequate to support continuous vertical flight. Accordingly, battery power must be supplemented by an internal combustion-powered generator, which is able to provide large amounts of sustained power efficiently. Unfortunately, turbine powered generators have slow response times due to inherent inertial properties and therefore are unable to respond in a timely manner to changes in power demand, either increasing or decreasing.

During some phases of flight, the hybrid powerplant can supply more power than is required for flight. During such conditions, excess generator power is routed to the batteries for charging. However, since the batteries can only absorb a limited amount of current over a period and in total before incurring damage, if the excess power routed to the batteries exceeds battery limits, faults and a total powertrain shutdown can result.

FIG. 3 present a battery power optimization curve as would be known to one of reasonable skill in the relevant art. Each battery produces power 310 in response to a current demand 320. As demand is low, the relationship between power and demand is substantially linear. However, as demand increases the amount of power produced per incremental increase in demand decreases until a point is reached as which the slope of the curve is zero. At this point, or the peak power point 340, the battery is producing maximum power. Any further increase in demand results in less power delivered and can result in damage to battery. The present invention manages demand placed on each battery to remain in the region of the curve possessing a positive slope.

In other phases of flight, such as in a climb, or when the batteries are depleted, both the generator and the battery modes could be operating at or near full output capability. If the aircraft autopilot continues to demand more power from the system, the batteries may enter an overcurrent or undervoltage condition, causing a catastrophic chain of powerplant faults. Therefore, power management strategies are required to prioritize the needs of the two largest power consumers on the aircraft, namely the FP system and the VL system.

The power management system described herein includes an interdependent set of powertrain control algorithms to ensure power generation and power absorption are kept within safe limits for all constraints, including component tolerances and vehicle controllability.

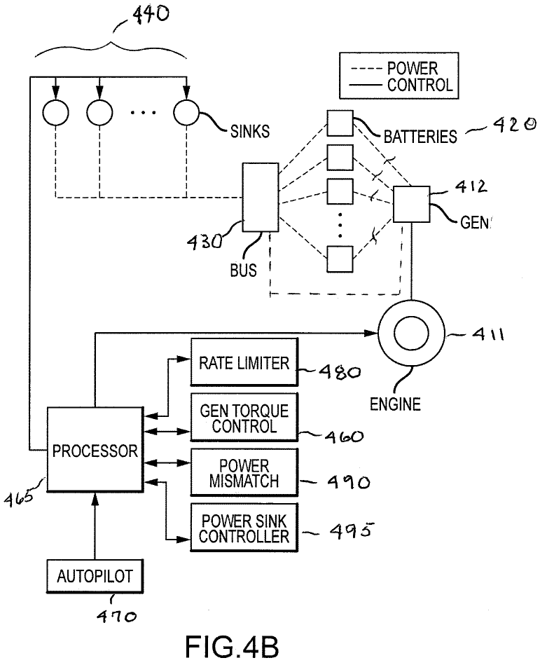

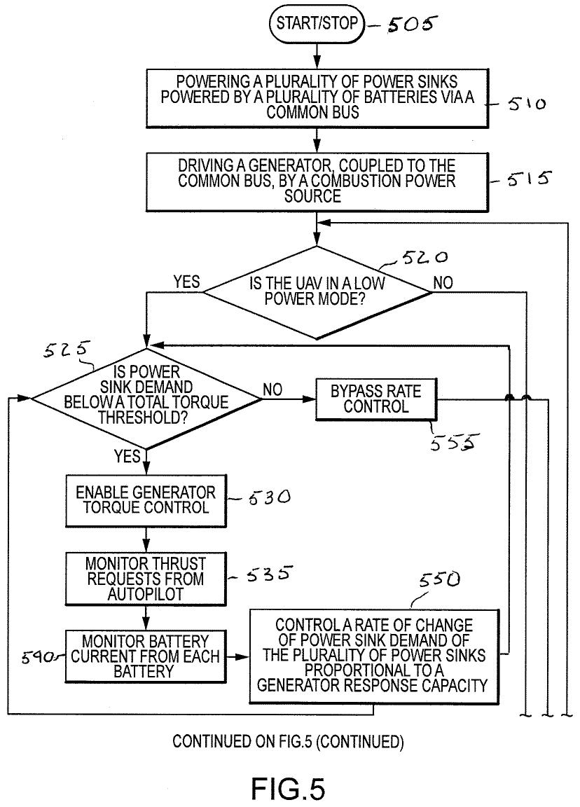

With reference to FIG. 4, the major components of the power management system are depicted in a block diagram. A turbogenerator module 410 includes a petroleum powered turbine 411 for power generation, a generator 412 for translating the turbine output into electrical power, and an inverter 413 to convert the direct current (DC) from the generator into alternating current (AC). The turbogenerator supplies electrical power to a battery pack 420 and a set of thrusters 440 via a central bus 430. The battery pack 420 includes a plurality of high voltage battery units 421 (two are shown) and supplies electrical power to the thrusters via the bus 430. The battery pack 420 receives charging current from the turbogenerator 410. The turbogenerator and battery pack supply electrical power to a set of thrusters 440, which include eight vertical lift motors 441 (one is shown) and four forward propulsion motors 442 (one is shown). The thrusters each include an inverter to convert supplied current back to DC, a multiphase high voltage electric motor and a propeller. A set of sensors 450 measures current input and output of the bus, turbogenerator, battery pack, and thrusters.

Power management is accomplished through a set of controllers. A powertrain torque controller 460 includes an algorithm that controls the amount of torque applied to the turbine 411, which in turn controls the amount of power generated by the generator 412, and hence the amount of electrical current supplied to the battery pack 420 and the thrusters 440. The torque controller has two basic states, either it is enabled, i.e., active, or it is disabled. When the turbogenerator is operating at less than its maximum output or its saturation point, the torque control is enabled. When enabled, the torque controller attempts to adjust generator output based on power demand. As power demand goes up, the torque controller commands the generator to increase its output up to the turbogenerator's saturation point. At saturation, the torque controller is no longer providing torque adjustments, and the turbogenerator holds its output at maximum. When power demand decreases below the saturation point, the torque controller is again active, and commands the generator to adjust output in accordance with power demands.

Because the turbogenerator output changes slowly due to the spin up-spin down dynamics of the turbine, the torque controller attempts to set generator output at a target current needed to charge the batteries to a set level within a reasonable time. The torque control algorithm therefore takes as input an estimated state of charge of the batteries, and a target state of charge, which is, e.g., 98%. The torque controller calculates the difference between the estimated and target charge levels and then calculates a target battery current needed to reach the target within a reasonable period. The torque controller then limits the target current to within a safe range and then converts the modified target current into a generator torque value.

An autopilot 470 includes a feedback control system that receives input from an inertial navigation system (INS) 471 and pilot flight control inputs 472 and uses those inputs to allocate thrust to each thruster 440 to control aircraft directional flight and maintain stability. In the process of executing a flight profile, the autopilot determines what aircraft attitude and position are required on a continuous basis. To maintain the aircraft on the flight profile, the autopilot determines what thrust is required from each thruster and issues its commands in the form of currents to be supplied by the system to each thruster. The autopilot is configured to efficiently allocate thrust to conserve power. For example, if the autopilot receives a command to accelerate the aircraft forward, its thrust commands may include an increase in power to the FP thrusters as well as a decrease in power to forward VL thrusters, causing the nose to pitch down and the aircraft to enter a slight descent. In this way, the autopilot uses potential energy to conserve onboard power.

Some embodiments include a rate limiter 480 that comprises an algorithm that limits the rate of change of thrust commands to the thrusters 440 to protect the thrusters and the battery pack 420. Like the torque controller, the rate limiter has two basic statuses: when the system is below an activation threshold, the rate limiter is active, and when conditions are above the activation threshold, the rate limiter is in bypass mode. The rate limiter's activation threshold is a “total torque” value, i.e., the sum of individual thruster torque values for all thrusters. Below the total torque threshold, the rate limiter actively manages the autopilot 470 inputs to the thrusters 440.

The rate limiter receives various inputs that allow it to perform its role. These include thrust requests from the autopilot 470 in the form of required currents to be supplied to each thruster 441, 442. These required currents represent the instantaneous power requirements for the system. The second input to the rate limiter 480 is the instantaneous measured battery current output from the battery pack 420, which represents the power available from the battery pack. The third input is the status of the torque controller 460 as enabled or disabled. The enabled/disabled status of the torque controller informs the rate limiter if any additional power is available from the turbogenerator, and whether the turbogenerator will adjust power output in response to changing demands. The rate limiter also accounts for the maximum ramp rates for the thrusters, which are different values for thruster ramp up, and thruster ramp down. Maximum thruster ramp rates are slower with the torque controller enabled versus disabled. The rate limiter also accounts for the battery pack's safe maximum discharge current and maximum safe charge current. Based on these inputs and parameters, the rate limiter adjusts the autopilot's required current commands for each thruster, protecting the thrusters from thrust commands more than the available thrust, and protecting the battery pack from excessive charge or discharge.

A challenge with the rate limiter is that the activation level must be set well below the torque value required for aircraft takeoff. This means the rate limiter is unable to protect the powertrain from rapid thrust command changes when the powerplant is ramping up and down before and after takeoff. In such scenarios, the powertrain may be protected through conservative piloting, or the generator may have its output capped well below its maximum output. Such steps lower the risk of overcharging the batteries during take-off.

Another challenge for the rate limiter is setting the maximum thruster ramp up and ramp down rates when the torque controller is enabled and generator power is variable. Thruster ramp rates during this flight regime are dependent on the turbogenerator spin up and spin down rates. The turbogenerator change rates are empirically determined based on aircraft performance, and the thruster ramp rates are set below the generator change rates. Because the generator ramp rates are estimations, the developed thruster ramp settings can allow battery overcharge during aircraft descent flight regimes.

Some embodiments include a power mismatch controller 490 that comprises an algorithm that limits autopilot 470 thrust commands to ensure overall thruster 440 power demand remains below total available power. The power mismatch controller receives inputs from the system to allow its operation, including an instantaneous measurement of load voltage and load current on the bus 430, the instantaneous current measurement for each battery pack 421, and the thrust commands from the autopilot 470. From these inputs, the power mismatch controller develops adjusted thruster commands to ensure total power demanded stays below the total power available. The power mismatch controller adjusts thrust commands according to a priority system. Each thrust command is assigned a priority value based on their effect on roll, pitch, yaw, longitudinal, lateral, or vertical. Thrust commands contributing to roll, pitch, and vertical are given highest priority to maintain altitude and stability, while yaw, lateral, and longitudinal are deprioritized. If power demand exceeds available power, the power mismatch controller adjusts autopilot thrust commands to allow a degradation in deprioritized axes to maintain critical function without exceeding power requirements.

A challenge with the power mismatch controller is the instantaneous bus voltage value used to determine available power. Power available to the system when operating at high power levels is inexact largely because determining the amount of power supplied by the turbogenerator at any point in time is difficult. As a result, the estimate for generator power must be assembled from indirect sources, such as battery power levels. Battery power levels and other indirect proxy measurements, however, are asynchronous and have different latency values from each other. Because of these deficiencies in the voltage value, there are transient periods during which the power mismatch controller may estimate more power than is available. To compensate, workarounds may be used, such as subtracting a buffer from the power availability measurement or applying a low pass filter to the power availability measurement to reduce noise in the measurement.

The power management system generally manages power output by the turbogenerator and power use by the thrusters and battery pack. Power generation is primarily managed through the torque controller 460, that manages generator operation. The torque controller increases generator output in response to increasing demand until the generator reaches its maximum power output, or saturation point.

Power absorption is primarily managed via the rate limiter 480 for low power scenarios, or the power mismatch controller 490 for high power scenarios. Each of these controllers acts to modulate the power demands of the FR and VL systems based on instantaneous power demands, and overall power demands, respectively. Power absorption control is most critical in two scenarios: (1) the aircraft is operating at low power and power demands are ramping up or down, or (2) the aircraft is operating near power saturation when additional demands can be made on the system. In the first scenario, large instantaneous power demands could exceed the amount of power the battery pack can supply, causing thruster failure, and large instantaneous power reductions could cause the turbogenerator to route excess power to the battery, causing a battery overvoltage. In the second scenario, the power demanded could exceed the amount of power the powerplant can supply, causing thruster failure.

For the low power scenario, the system uses the rate limiter 480 to perform power management. At low power flight regimes, the turbogenerator is operating below its saturation point, meaning the torque controller is active. Similarly, the total torque value of the thrusters is below the activation threshold, so the rate limiter is also active. When operating in this mode, the torque controller actively adjusts turbogenerator output in response to power demands, but the turbine has a certain lag time. Therefore, rapid changes to power demand will be absorbed primarily by the batteries. Rapid increases in power demand on the batteries could cause them to exceed their safe discharge limits, while rapid decreases in power demand could cause the system to route too much battery charging current from the generator, causing the batteries to exceed their safe charging limits. The rate limiter adjusts autopilot thrust commands to prevent instantaneous power commands that exceed battery discharge limits, and to allow more time for the high-inertia generator to catch up with changing power demands.

Modified thrust commands are generated based on the prior thrust command for each thruster plus or minus a linear increment. For each new thrust command, the rate limiter compares the previous thrust command for each thruster with the new thrust command and compares the instantaneous battery current value with the safe charge and discharge limits. The rate limiter then chooses an increment according to the following scenarios: If the thrust command is decreasing and instantaneous battery current is above its safe charge threshold, the rate limiter chooses a “decreasing hold” increment, which is small but nonzero to ensure convergence with the desired command. If the thrust command is decreasing and instantaneous battery current is below the safe charge threshold, the rate limiter chooses a “nominal decreasing” increment, which allows quicker convergence with the autopilot command. Similarly, if the thrust command is increasing and instantaneous battery current is below the safe discharge threshold, the rate limiter adds an “increasing hold” increment, while an increasing thrust command with the battery below the safe discharge threshold, the rate limiter adds a “nominal increasing” increment.

In some embodiments, the system includes a physical power sink to address the scenario in which a rapid decrease in commanded thrust could cause the generator to route excess current to the batteries resulting in an overcharge. Such a power sink could be, for example, a high-capacity resistor with cooling apparatus, that is configured to receive and dissipate the excess power.

For the high power scenario, the system relies on the power mismatch controller 490 to manage power demands. At high power flight regimes, the turbogenerator 410 is operating at its saturation point, so the torque controller 460 is also saturated and not applying corrections. The total torque value of the thrusters may be above or below the activation threshold, so the rate limiter 480 may be active. If the rate limiter is active, autopilot 470 thrust commands will be adjusted by the power mismatch controller and then receive further adjustment from the rate limiter. Upon receiving thrust commands from the autopilot via the rate limiter, the power mismatch controller first calculates the total power required to achieve the thrust commands. Then the controller compares the total power required to the power available. If the powerplant has sufficient power available, the controller makes no further modifications to the thrust commands. If the available power is insufficient, the power mismatch controller reallocates power from the yaw, lateral, and longitudinal degrees of freedom to the roll, pitch, and vertical degrees of freedom. Once it has reallocated power, the power mismatch controller applies modifications to the thrust commands for each thruster.

FIG. 4B provides an additional point of view of the hybrid power optimization system of the present invention. As described above power is supplied to a plurality of power sinks (thrusters) 440 via a common bus 430. Power is supplied to the bus 430 via connection to a plurality of batteries 420 and a generator drive 412 by a combustion power source, such as a turbine engine. When power demand is high the power supplied to the power sinks exceeds that of the generator at full capacity resulting in a discharge of power from the batteries. When power demand is low power supplied to by the generator can not only meet the demand of the thrusters but supply power to recharge depleted cells within the battery. Once charged power produced by the generator can match that of the power sink demand. The responsiveness of the generator is slow. Accordingly immediate demands of the power are meet by resources found in the battery until the generator can adjust power production.

Control of power sink demand employs multiple inputs to a processor 465 and interactions of various modules. The flight autopilot or similar flight control input is a primary delivery means of flight control demands. Those inputs resulting in thruster demands are managed by a power sink controller through input, interdependencies and control factors found in a demand rate limiter 480, a generator torque control 460, and power mismatch handler 490.

To better understand the interdependencies of the hybrid power optimization system of the present invention consider the following example. Assume a VTOL UAV includes a plurality of electric power vertical and horizontal thrusters (motors) coupled to a plurality of batteries. The UAV also includes a combustion based turbine engine coupled to a generator which is in turn coupled to the batteries. The UAV is designed to deliver cargo via a vertical takeoff, transition to conventional horizontal flight and then re-transition for a vertical landing. As the batteries are discharging to supply power to the relevant thrusters, the generator, driven by the turbine is replenishing the batteries. Cargo capacity and range are directly related to the weight of the power systems.

In one embodiment of the present invention and in accordance with this example, the charge of the batteries is in a constant flux. In flight modes requiring high demands of vertical thrust, namely takeoff and landing, the rate of discharge of the batteries exceeds the ability of the generator to replenish them. During horizontal flight the ability of the generator to replenish battery charge exceeds the demand of the thrusters. Assuming the batteries are fully charged prior to take off, an autopilot command to lift off vertically will direct a substantial increase in power demand from the batteries. A sudden spike in demand to the motors and thus a sudden drain of power from the batteries can damage the batteries. Accordingly, in a low power mode, e.g. on the ground ready for takeoff, the rate of change of demand on the batteries is limited.

Concurrently a generator torque control commend is issued to the turbine to increase torque to the generator thereby producing more electricity. As the demand for and use of power at the thrusters increases, so does the command to the turbine driven generator to generate more electricity. Eventually the generator is operating at capacity or saturation. As the UAV lifts off discharge of the batteries will exceed to capacity of the generator to replenish the charge, despite being at full saturation.

At some point during takeoff, the system may become aware that the remaining charge is the batteries is approaching a critical threshold. At that point the power mismatch handling code prioritizes command for roll, pitch and vertical degrees of freedom, sacrificing control of yaw, lateral and longitudinal degrees of freedom.

As the UAV transitions to horizontal flight demand for vertical thrust diminishes, eventually reaching zero, as the wings of the UAV provide sufficient lift for flight. As the vertical thrusters are no longer demanding power, the generator is not capable of replenishing the batteries to at or near a fully charged state.

In this example the UAV transitioned from a low power mode (on the ground) to a high power mode (takeoff), a mid-range mode (transition to horizontal flight) and back to a low power mode (horizontal flight). The same process happens in reverse when the UAV arrives at its destination and transitions from horizontal flight to vertical operations for landing. The power system of the present invention manages power generation by the gas turbine and its ability to charge the batteries as well as the demands placed on the batteries to control charging and discharging rates.

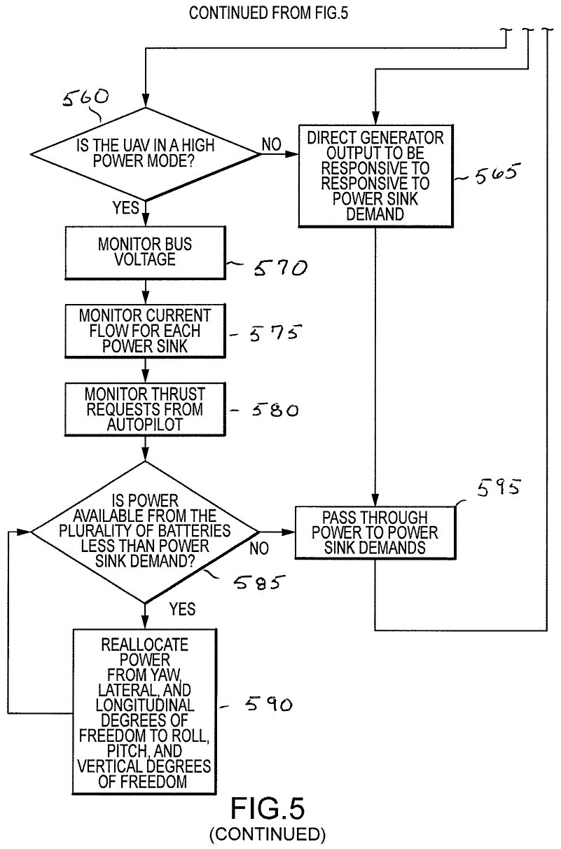

FIG. 5 presents a flowchart of one methodology for UAV hybrid power management according to one embodiment of the present invention. The process begins 505 by powering 510 a plurality of thrusters (sinks) by a power source such as a plurality of batteries. The batteries are coupled to a common bus as is a combustion powered generator 515. In one example the generator is driven by a gas turbine engine.

An inquiry 520 is made whether the UAV is a low power mode. In a low power mode, the system further queries 525 whether the power sink demand is below a total torque threshold. If so, a generator torque control algorithm is enabled 530 limiting the rate of demand while manipulating the performance of the combustion engine and thereby the generator. Thrust requests from the autopilot are monitored 535 as is battery current state 540. With this information the rate of control of power sink demands by the power sinks on the batteries is controlled 550 to be proportional to the responsiveness of the generator.

When in a low power mode and power sink demand is above the total torque threshold the torque rate control is bypassed 555.

If the UAV is not in a low power mode the system queries 560 if it is in a high power mode such as experienced during takeoffs and landings. If the UAV is neither in a low power nor a high power mode, the system directs 565 the generator output to be responsive to power sink demands. When the query is affirmative, (i.e. the UAV is in a high power mode) the bus voltage is monitored 570 as is the current flow 575 to each power sink and thrust requests 580 from the autopilot or user inputs. With this information the system determines 585 if power available from the plurality of batteries is less than the demands of the power sinks as directed by the autopilot. If demand is higher than the power available, in a high power mode, power is reallocated 590 from yaw, lateral and longitudinal degrees of freedom of the UAV to roll, pitch and vertical degrees of freedom.

If power available is greater than the power demand the control requests are passed through 595 to the power sinks. The inquiry as to low, high or mid power modes is recursive.

While this invention has been described in terms of several embodiments, there are alterations, modifications, permutations, and substitute equivalents, which fall within the scope of this invention. It should also be noted that there are many alternative ways of implementing the methods and apparatuses of the present invention.

In another embodiment of the present invention, UAV power optimization is enabled by powering a plurality of power sinks by a plurality of batteries. One of reasonable skill in the relevant art will appreciate that batteries are one form of power storage device. The present invention uses the term batteries inclusive of other power storage devices including capacitors, flywheels, thermal storage, mechanical storage, and electromechanical storage devices. Use of all of which are contemplated and within the scope of the present invention.

The process continues by driving a generator by a combustion power source such as a piston or turbine based engine. The generator is coupled to, and supplies, power to each of the plurality of batteries.

As described herein, the batteries are coupled to and provide power to a plurality of power sinks. A plurality of program codes for power optimization comprising instructions executable by a machine control of power distribution to each of the power sinks as well as, among other things, charging and discharging rates of each of the plurality of batteries.

In one embodiment of the present invention the methodology for power optimization controls the rate of change of power sink demand of the plurality of power sinks below a total torque threshold proportional to generator response capacity.

In another embodiment of the present invention, the power optimization methodology directs generator output responsive to power sink demand. And in yet another embodiment of the present invention, power is reallocated from yaw, lateral and longitudinal degrees of freedom to roll, pitch and vertical degrees of freedom responsive to power available from the plurality of batteries bine less than power sink demand.

It will also be understood by those familiar with the art, that the invention may be embodied in other specific forms without departing from the spirit or essential characteristics thereof. Likewise, the naming and division of the modules, managers, functions, systems, engines, layers, features, attributes, methodologies, and other aspects are not mandatory or significant, and the mechanisms that implement the invention or its features may have different names, divisions, and/or formats. Furthermore, as will be apparent to one of ordinary skill in the relevant art, the modules, managers, functions, systems, engines, layers, features, attributes, methodologies, and other aspects of the invention can be implemented as software, hardware, firmware, or any combination of the three. Of course, wherever a component of the present invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming. Additionally, the present invention is in no way limited to implementation in any specific programming language, or for any specific operating system or environment. Accordingly, the disclosure of the present invention is intended to be illustrative, but not limiting, of the scope of the invention, which is set forth in the following claims.

In a preferred embodiment, the present invention can be implemented in software. Software programming code which embodies the present invention is typically accessed by a microprocessor from long-term, persistent storage media of some type, such as a flash drive or hard drive. The software programming code may be embodied on any of a variety of known media for use with a data processing system, such as a diskette, hard drive, CD-ROM, or the like. The code may be distributed on such media or may be distributed from the memory or storage of one computer system over a network of some type to other computer systems for use by such other systems. Alternatively, the programming code may be embodied in the memory of the device and accessed by a microprocessor using an internal bus. The techniques and methods for embodying software programming code in memory, on physical media, and/or distributing software code via networks are well known and will not be further discussed herein.

Generally, program modules include routines, programs, objects, components, data structures and the like that perform tasks or implement abstract data types. Moreover, those skilled in the art will appreciate that the invention can be practiced with other computer system configurations, including hand-held devices, multi-processor systems, microprocessor-based or programmable consumer electronics, network PCs, minicomputers, mainframe computers, and the like. The invention may also be practiced in distributed computing environments where tasks are performed by remote processing devices that are linked through a communications network. In a distributed computing environment, program modules may be in both local and remote memory storage devices.

An exemplary system for implementing the invention includes a general purpose computing device such as the form of a conventional personal computer, a personal communication device or the like, including a processing unit, a system memory, and a system bus that couples various system components, including the system memory to the processing unit. The system bus may be any of several types of bus structures including a memory bus or memory controller, a peripheral bus, and a local bus using any of a variety of bus architectures. The system memory generally includes read-only memory (ROM) and random access memory (RAM). A basic input/output system (BIOS), containing the basic routines that help to transfer information between elements within the personal computer, such as during start-up, is stored in ROM. The personal computer may further include a hard disk drive for reading from and writing to a hard disk, a magnetic disk drive for reading from or writing to a removable magnetic disk. The hard disk drive and magnetic disk drive are connected to the system bus by a hard disk drive interface and a magnetic disk drive interface, respectively. The drives and their associated computer-readable media provide non-volatile storage of computer readable instructions, data structures, program modules and other data for the personal computer. Although the exemplary environment described herein employs a hard disk and a removable magnetic disk, it should be appreciated by those skilled in the art that other types of computer readable media which can store data that is accessible by a computer may also be used in the exemplary operating environment.

Embodiments of the present invention as have been herein described may be implemented with reference to various wireless networks and their associated communication devices. Networks can also include mainframe computers or servers, such as a gateway computer or application server (which may access a data repository). A gateway computer serves as a point of entry into each network. The gateway may be coupled to another network by means of a communications link. The gateway may also be directly coupled to one or more devices using a communications link. Further, the gateway may be indirectly coupled to one or more devices. The gateway computer may also be coupled to a storage device such as data repository.

As will be understood by those familiar with the art, the invention may be embodied in other specific forms without departing from the spirit or essential characteristics thereof. Likewise, the naming and division of the modules, managers, functions, systems, engines, layers, features, attributes, methodologies, and other aspects are not mandatory or significant, and the mechanisms that implement the invention or its features may have different names, divisions, and/or formats. Furthermore, as will be apparent to one of ordinary skill in the relevant art, the modules, managers, functions, systems, engines, layers, features, attributes, methodologies, and other aspects of the invention can be implemented as software, hardware, firmware, or any combination of the three. Of course, wherever a component of the present invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming. Additionally, the present invention is in no way limited to implementation in any specific programming language, or for any specific operating system or environment. Accordingly, the disclosure of the present invention is intended to be illustrative, but not limiting, of the scope of the invention, which is set forth in the following claims.

While there have been described above the principles of the present invention in conjunction with an UAV hybrid power optimization system, it is to be clearly understood that the foregoing description is made only by way of example and not as a limitation to the scope of the invention. Particularly, it is recognized that the teachings of the foregoing disclosure will suggest other modifications to those persons skilled in the relevant art. Such modifications may involve other features that are already known per se and which may be used instead of or in addition to features already described herein. Although claims have been formulated in this application to particular combinations of features, it should be understood that the scope of the disclosure herein also includes any novel feature or any novel combination of features disclosed either explicitly or implicitly or any generalization or modification thereof which would be apparent to persons skilled in the relevant art, whether or not such relates to the same invention as presently claimed in any claim and whether or not it mitigates any or all of the same technical problems as confronted by the present invention. The Applicant hereby reserves the right to formulate new claims to such features and/or combinations of such features during the prosecution of the present application or of any further application derived therefrom.

We claim:

1. An Unmanned Aerial Vehicle (UAV) hybrid power optimization system, comprising:
a plurality of batteries;
a plurality of power sinks powered via a common bus by the plurality of batteries;
a generator driven by a combustion power source operable to supply power to the common bus; and
a program of instructions executable by a machine wherein said program of instruction comprises a plurality of program codes for power optimization, said program of instruction comprising
program code for a rate limiter operable to control a rate of change of power sink demand of the plurality of power sinks below a total torque threshold proportional to a generator response capacity
program code for generator torque control wherein the program for generator torque control directs generator output responsive to power sink demand, and
program code for power mismatch handling wherein, responsive to power available from the plurality of batteries being less than power sink demand, the program code for power mismatch reallocates power reallocates power directed to yaw, lateral, and longitudinal degrees of freedom to roll, pitch, and vertical degrees of freedom.

2. The UAV hybrid power optimization system of claim 1, wherein each of the plurality of power sinks is a vertical or horizontal thruster.

3. The UAV hybrid power optimization system of claim 1, wherein the program code for the rate limiter monitors a battery state of each of the plurality of batteries and controls the rate of change of power sink demand so as not to exceed a maximum battery discharge capacity.

4. The UAV hybrid power optimization system of claim 3, wherein the battery state includes instantaneous battery current discharge.

5. The UAV hybrid power optimization system of claim 3, wherein the battery state includes battery voltage.

6. The UAV hybrid power optimization system of claim 1, wherein the program code for power mismatch handling receives power available data from each of the plurality of batteries.

7. The UAV hybrid power optimization system of claim 1, further comprising a power sink controller communicative coupled to the machine and wherein the power sink controller issues commands to each of the plurality of power sinks in a high power mode, a low power mode or a mid-range mode.

8. The UAV hybrid power optimization system of claim 7, wherein responsive to the UAV being in a takeoff or landing control mode, the power sink controller is in a high power mode.

9. The UAV hybrid power optimization system of claim 8, wherein responsive to the power sink controller being in the high power mode and the program code for power mismatch handling power reallocation, the power mismatch controller applies modifications to commands for each power sink.

10. The UAV hybrid power optimization system of claim 1, wherein in high power mode power demand of the plurality of power sinks exceeds capacity of the plurality of batteries and capacity of the generator.

11. The UAV hybrid power optimization system of claim 7, wherein responsive to the UAV being in a horizontal flight mode, the power sink controller is in the low power mode.

12. The UAV hybrid power optimization system of claim 11, wherein the program code for the rate limiter is activated responsive to the power sink controller being in the low power mode and the power sink demand of the plurality of power sinks being below the total torque threshold.

13. The UAV hybrid power optimization system of claim 11, wherein the program code for the rate limiter is bypassed responsive to the power sink controller being in the low power mode and the power sink demand of the plurality of power sinks being above the total torque threshold.

14. The UAV hybrid power optimization system of claim 7, wherein responsive to the UAV transitioning between horizontal and vertical flight, the power sink controller is in the mid-range mode.

15. The UAV hybrid power optimization system of claim 1, wherein the combustion power source is a turbine engine.

16. A method for Unmanned Aerial Vehicle (UAV) hybrid power optimization, the method comprising:
powering a plurality of power sinks powered by a plurality of batteries via a common bus;
driving a generator by a combustion power source wherein the generator supplies power to the common bus; and
executing by a machine a program of instructions wherein said program of instruction comprises a plurality of program codes for power optimization, said program of instruction causes the machine to
control, by a rate limiter, a rate of change of power sink demand of the plurality of power sinks proportional to a generator response capacity responsive to power sink demand being below a total torque threshold
direct, by a generator torque control, generator output responsive to power sink demand, and
reallocate, by a power mismatch handler, power from yaw, lateral, and longitudinal degrees of freedom to roll, pitch, and vertical degrees of freedom, responsive to power available from the plurality of batteries being less than power sink demand.

17. The method for UAV hybrid power optimization according to claim 16, wherein the program code further monitors a battery state of each of the plurality of batteries and controls the rate of change of power sink demand so as not to exceed a maximum battery discharge capacity.

18. The method for UAV hybrid power optimization according to claim 16, wherein the program code further bypasses control of the rate of change of power sink demand of the plurality of power sinks responsive to the power sink demand of the plurality of power sinks being above the total torque threshold.
